(19) United States
(12) Patent Application Publication
(10) Pub. No.: US 2012/0284140 A1
(43) Pub. Date: Nov. 8, 2012

(54) Method for Drop Auction of an Entity, Electronic System and Computer Program Product

(75) Inventor: Petrus Mattheus Maria Hoff, Roosendaal (NL)

(73) Assignee: HOLDING P.M.M. HOFF B.V., Steenbergen (NL)

(21) Appl. No.: 13/456,382

(22) Filed: Apr. 26, 2012

Related U.S. Application Data
(60) Provisional application No. 61/479,946, filed on Apr. 28, 2011.

(30) Foreign Application Priority Data
Apr. 28, 2011 (NL) 2006684

(51) Int. Cl. G06Q 30/08

(52) U.S. Cl. 705/26.3

(57) ABSTRACT

A method for drop auction of an entity comprises providing an electronic system for auction of an entity, and allowing a selling party to enter a definition of the entity to be auctioned and a maximum asking price into the electronic system. An asking price which drops stepwise from the maximum asking price to a minimum asking price is determined. The entity is electronically offered by informing potential buyers about the current asking price. The number, the size and/or the duration of the steps by which the asking price drops is predetermined by a manager of the electronic system.

The invention relates to a method for drop auction of an entity.

Via the Internet numerous trading places are created where sellers and buyers try to get to business. On most trading sites there is an offer by the seller with a fixed price. Buyers visit the site and can make a bid. The buyer making the highest bid becomes the owner of the product. This manner of selling is referred to as an ascending-price auction or bidding auction. Sometimes a seller is unable to dispose of his merchandise and lowers the price. Thereupon buyers can bid again. Basically, the flaw of this model is that buyer and seller have great difficulty finding an optimum price. This is especially because the action of finding the optimum price has to be done manually; in addition, psychological factors play an adverse role, because many buyers are afraid to make a bid. Next to this, there is the more dynamic principle of the descending-price auction or Dutch auction. Also, there are so-called reverse auctions, but these work with static price changes, which need to be applied by the buyers themselves. Moreover, there are no automated systems that control the price changes on the basis of measured market potential.

According to the invention, a method is provided which comprises the steps of providing an electronic system for auction of an entity, allowing a selling party to enter a definition of the entity to be auctioned into the electronic system, allowing the selling party to enter a maximum asking price, determining an asking price which drops stepwise from the maximum asking price to a minimum asking price, and electronically offering the entity by informing potential buyers about the current asking price, wherein the number, the size and/or the duration of the steps by which the asking price drops is predetermined by a manager of the electronic system.

By arranging for the number, the size and/or the duration of the steps by which the asking price drops to be determined beforehand by a manager, e.g., the auctioneer, of the electronic system, a relatively simple method for an auction is obtained. A selling party presently only needs to enter a limited number of parameters, so that setting an auction process into motion can be done relatively simply. Also, this simplicity creates clarity in functioning vis-à-vis other participants in the auction process.

It is noted that the word ‘entity’ may be understood to mean a product or a service.

Preferably, the step size is constant. However, in principle, the step size may also be chosen to be varying. The number of steps can be chosen in a range of between about 10 and about 1,000, or beyond, e.g., 10,000. Most preferably, the number of steps is fixed at 100. The reason is that this number is easy to handle and makes the auction process extremely transparent to the participating parties. Furthermore, the duration of the individual steps, also referred to as “recognizable time factor”, may be chosen in a range of between about one second and about one year. Thus, the recognizable time factor may be fixed at a second, a minute, a quarter of an hour, an hour, a week, a month, or a year. Obviously, other time factors are possible, e.g., 2 or 3 months.

Furthermore, the method may be so arranged that the selling party can enter the minimum asking price. If this is not done, the minimum asking price may be fixed automatically, e.g., at zero. Given constant steps, the step size may be determined by dividing the difference between the maximum asking price and the minimum asking price by the number of steps. Thus, per step, this results in a reduction of the asking price by a fixed percentage of the maximum asking price.

The electronic offering of the entity may be terminated by allowing a buying party to accept the asking price in the electronic system. The sale is then concluded. When no asking price is accepted, electronic offering of the entity is terminated upon expiry of a predetermined period of time in which the entity was on offer for the minimum asking price. The entity then is not sold.

Optionally, a potential buyer receives a message, called Article Alert, when an entity preselected by the potential buyer is on offer. Such a selected entity may, for instance, be stored in a database. The location of the entity to be sold or the place where the seller is, may be of influence. Thus, the database may be so arranged that an Article Alert is sent when an entity is on offer in a specific region or, conversely, globally.

Furthermore, a potential buyer can receive a message, sometimes called Price Alert, when the asking price approaches an amount which has been prefixed by the potential buyer, so that the potential buyer's attention can be drawn to a relevant phase of the auction process. Also, the electronic system may automatically receive from a potential buyer a message of acceptance, sometimes called Auto Mine, when the asking price reaches an amount prefixed by the potential buyer. Thus, the potential buyer can react in an automated manner when the desired price level has been reached. For that matter, the electronic system may receive from a potential buyer a message, sometimes called Mine Alert, which includes a bid for the entity, fixed by the potential buyer, so that the seller can decide to accept the bid submitted, or not to accept the bid and to let the auction process continue.

The above-described process is also denoted as single drop auction.

A specific embodiment of such a method for a single drop auction is described below.
1. The selling party enters into the electronic system a definition of, and a maximum asking price of 100× for, the entity to be auctioned. Also, he enters a desired starting time for the auction. All potential buyers who have preselected the entity to be auctioned receive a message to inform them that the entity desired by these potential buyers is on offer.
2. From the starting time, the asking price drops every quarter of an hour, for 25 hours, by a step of a size of 1% of the maximum asking price, until after 100 steps the minimum price of 0× has been reached.

Alternatively, the minimum price may also be higher than 0×. Thus, the minimum price may be, e.g., 50×, 40×, 30×, 20×, 10×. The size of the steps by which the price is lowered in such cases is 1% of the difference between the maximum asking price and the minimum price.

The minimum price may be entered into the system by the seller. However, the minimum price may alternatively be prefixed by the manager of the electronic system.
3. The first potential buyer who stops the dropping process wins the auction and becomes the buyer of the entity.

He may do this, e.g., manually, e.g., by clicking on a button of a user interface, with the aid of a personal computer.

Alternatively, the potential buyer can have such stopping done automatically by the system. To this end, before the current price of the entity on offer has dropped to an amount fixed by the potential buyer, i.e., an asking price acceptable to the potential buyer, the potential buyer can enter this acceptable amount into the system. When the asking price of the entity has subsequently dropped to this fixed amount, the system can automatically accept this asking price on behalf of the potential buyer who thereby wins the auction and becomes the buyer of the entity.
4. Thereupon the payment process can commence. The seller is paid by the buyer. Possibly, the manager and/or auctioneer charges a commission.
5. During the auction, different instruments may be available that can simplify the auction process.
6. Thus, users of the system may have, for instance, one or a plurality of databases available to them in which they may enter entities wanted by them. Subsequently, potential buyers who have preselected a particular entity to be auctioned as a wanted entity, can receive a message to notify them that the entity sought by these potential buyers is on offer.
7. Another possible instrument is a Price Alert. A potential buyer may then, e.g., via an e-mail, be notified by the system that the asking price is approaching or has reached a desired price level entered by this potential buyer.
8. Yet another instrument is a so-called AutoMine button. With it, the potential buyer can enter an asking price acceptable to him. When the asking price of the entity has dropped to this acceptable asking price, the asking price is automatically accepted on behalf of this potential buyer.
9. Optionally, a seller may get a so-called Mine Alert when a potential buyer has entered an asking price acceptable to this potential buyer. The seller can then decide to accept this entered acceptable asking price and thereby end the auction. Alternatively, the seller can decide to continue the auction in the hope that, before the current asking price has dropped to the level of this entered acceptable asking price, a higher asking price will be accepted by this or another potential buyer.
   Effects of embodiments of and/or parts of a method for a single drop auction are described below, on the basis of advantages of the single drop auction to the seller and to potential buyers, and on the basis of disadvantages of existing systems such as an ascending-price or bidding auction, also named English auction.
1. In a bidding auction a selling party may be unsure about the starting price he is going to ask as a minimum. This plays a role especially if he has little experience with auctioning or if a non-regular entity is involved. Due to this, often a wrong price, or no price, is asked. Non-regular potential buyers, too, may be unsure if they have little experience with buying at an auction or when the auction of a non-regular entity is involved. As a consequence, they may refrain from bidding. In general, it may be stated that a slow auction process is characteristic of a bidding auction.
2. In a bidding auction a potential buyer often waits long before bidding so as to prevent the price being pushed up by him.
3. In the single drop auction an interested potential buyer is forced to adopt an active attitude.
4. As a result, the process of the single drop auction is rapidly traversed. In the above-described specific embodiment, e.g., within 25 hours. This can be a very important factor for many sellers. For instance, if the seller is hard up for money or, for instance, if he wants to sell perishable goods.
5. Furthermore, in the single drop auction there is always a price that can be accepted directly.
6. The seller in the single drop auction does not depend on particular group actions, on which a seller who makes use of a model such as the Groupon model does depend.
7. In the single drop auction the auctioneer and/or manager of the system takes care of a group of potential buyers by informing them through the so-called Article Alerts. Further, each potential buyer decides whether he wishes to accept an offer and at what price he does so.
8. Also, the seller in the single drop auction, if he so wishes, can fix a minimum asking price.
9. For a potential buyer in the single drop auction there is no uncertainty about the minimum price for which a seller wants to sell the entity.
10. As the auction process in the single drop auction can take place automatically for the most part, for instance, with the aid of instruments such as the Article Alert, the Price Alert, the Mine Alert and/or the AutoMine button, the auction process can take place while one or more of the parties, i.e., the seller and the potential buyers, are doing other things.
11. Also, the single drop auction is exciting to boot.
   In addition, the single drop auction may be advantageous for an auctioneer and/or manager of an electronic system for drop auction of an entity. Such advantages include:
1. There need not be any limitations on the number of sellers and/or entities to be auctioned. Nor is there, in principle, any limitation on the place where the buyers/sellers are. The information network, e.g., the Internet, can extend globally.
2. The exploitation costs can be relatively low.
3. A relatively low database capacity is needed, compared with the number of sales.
4. The users of the system, i.e., sellers, buyers and/or potential buyers, will typically be very satisfied owing to the fast results to be achieved.
5. Much revenue from commission can be generated.
6. With an electronic system, in addition, advertising revenues can be generated as well.
7. Alternatively or additionally, software written for the auction system can be licensed to other businesses, these other businesses then paying the auctioneer and/or manager of the system commission on the auctions facilitated by these other businesses.
8. The single drop auction also has a socially responsible side. Thus, it allows small producers, e.g., those of coffee, soy, or tea, to reach an international market, bypassing the purchasing cartels.
9. Moreover, the single drop auction is much more flexible than static sales models such as Ebay and Groupon.

According to a further aspect of the invention, a second auction round may be carried out, after acceptance of the current asking price by a provisional buyer. This process is also referred to as double drop auction. In it, a second, stepwise dropping, asking price is determined for the entity which is likewise electronically offered by informing potential buyers about the current second asking price. An agreed price for the entity is determined when a definitive buyer accepts a current second asking price. The agreed price then consists of the sum of the first accepted asking price and the second accepted asking price.

By carrying out the auction round doubly, an opportunity is offered to acquire, as a provisional buyer, revenues for entities that will be bought in the second round by another, definitive buyer. This gives the double drop auction principle its own dynamics.

Preferably, the method is so arranged that the provisional buyer is entitled to a percentage of the first accepted asking price. Another side of the concept is that it may then be agreed at the same time that the provisional buyer also becomes the definitive buyer when in the second auction round no asking price is accepted, so that the provisional buyer bears the risk of undertaking to buy the entity from the seller.

A specific embodiment of such a method for a double drop auction is described below.
1. A selling party enters into the electronic system a definition of, and a maximum asking price of 100× for, the entity to be auctioned. Also, he enters a desired starting time for a first auction round of the double drop auction. All potential buyers who have pre-selected the entity to be auctioned receive a message informing them that the entity desired by them is on offer.
2. From the starting time the asking price drops every quarter of an hour, for 25 hours, by a step of a size of 1% of the maximum asking price, until, after 100 steps, the minimum price of 0× has been reached. 3. Optionally, potential buyers can have a first instrument available to them, a so-called AutoMine button. With it, a potential buyer can enter an asking price acceptable to him. When the asking price of the entity has dropped to this acceptable asking price, the asking price is automatically accepted on behalf of this potential buyer. If this happens in the first auction round, this makes the potential buyer the provisional buyer.
4. Alternatively or additionally, potential buyers can have a so-called 2^{nd} Mine Alert instrument available to them. Potential buyers making use of this instrument are automatically informed, after the first auction round has ended, of the price of the first auction round eventually accepted by the provisional buyer and they are also informed of the starting time of the second auction round.
5. The first potential buyer who during the first auction round accepts the asking price and thus stops the dropping process, thereby determines the minimum price of the second auction round. Preferably, he is entitled to an amount of money, named Mine Money, if the entity is sold in the second auction round.
6. The Mine Money can be, e.g., 5% of the asking price acceptable in the first round. The Mine Money stimulates potential buyers to actively participate in the auction. Potential buyers who go for this Mine Money are named so-called Mine Hunters.
7. The second auction round starts, for instance, when, after the first auction round has ended, a period of time, e.g., 24 hours, fixed by the manager and/or auctioneer, has expired. Alternatively, a seller can enter a starting time into the system.

All potential buyers who make use of a Mine Alert, an Auto Mine or an Article Alert can receive a message to inform them that a second auction round with the entity monitored and/or wanted by them is going to start.
8. In the second auction round the price can drop faster than in the first auction round. For instance, the price in the second round drops in a hundred steps of 1% of the maximum asking price in the second round. The price in the second round drops, e.g., every minute.

The maximum asking price in the second round may be equal to the maximum asking price of the first round as defined by the selling party. Alternatively, the maximum asking price in the second round is not equal to the maximum asking price of the first round, and is, for instance, lower.
9. Optionally, potential buyers in the second round can have the AutoMine button available to them. With it, a potential buyer can enter an asking price acceptable to him. When the asking price of the entity has dropped to this acceptable asking price, the asking price is automatically accepted on behalf of this potential buyer. If this happens in the second auction round, this makes the potential buyer the buyer of the entity. The agreed selling price is then the sum of the asking price accepted in the first round and the asking price accepted in the second round. Thus, the asking price of the second round basically constitutes a kind of surplus on top of the asking price accepted in the first round.
10. Optionally, the seller may receive a so-called Mine Alert when a potential buyer in the second round has entered an asking price acceptable to this potential buyer. The seller can then decide to accept this entered acceptable asking price and thereby end the second round. Alternatively, the seller can decide to continue the auction in the hope that, before the current asking price has dropped to the level of this entered acceptable second asking price, a higher second asking price is accepted by this or another potential buyer.
11. Next, the payment process can commence. The seller is paid by the buyer. Possibly, the manager and/or auctioneer charge(s) a commission. Also, money may be deducted to pay the Mine Money to the winner of the first auction round.
12. The winner of the first auction round gets, e.g., 5% of the price he accepted in the first round.
13. During the auction different instruments may be at hand that can simplify the auctioning process.
14. Thus, users of the system may have a Price Alert instrument available to them. A potential buyer may thereby, for instance via an e-mail, be informed by the system that the asking price is approaching or has reached a desired price level entered by this potential buyer.
15. For the first round of the double drop auction the seller beforehand sets the starting price at 100×. Also, an option may be offered to him to set a minimum price of, e.g., 50×, 40×, 30×, 20× or 10×. The steps by which the first asking price drops are then, e.g., respectively 5, 6, 7, 8, or 9%0 of the maximum first asking price. For instance, the price drops over a period of 25 hours in 100 steps until the asking price has reached the minimum price.
16. For the second auction round of the double drop auction the seller can decide that the starting price in the second round will be equal to or lower than the starting price of the first round. Most preferably, he cannot set a minimum price.

Preferably, the second asking price drops in steps of 1% per minute. As a result, the second round can last 100 minutes at a maximum.
17. Optionally, the auctioneer can ask the seller to provide a guarantee, for instance, in the amount of 10% of the maximum first asking price. The seller may, for instance, be given an opportunity after the first auction round to sell the entity to a third party. Most preferably, the seller will then be obliged to pay commission to the auctioneer and to pay the Mine Money to the winner of the first round. These amounts may, for instance, be withheld from his guarantee.

Effects of embodiments of and/or parts of a method for a double drop auction are described below, on the basis of advantages of the double drop auction for the seller and for potential buyers, and on the basis of disadvantages of existing systems such as an ascending-price or bidding auction, also named English auction.
1. In a bidding auction a selling party may be unsure about the starting price he is going to ask as a minimum. This plays a role especially if he has little experience with auctioning or if the entity to be auctioned is a non-regular entity. Consequently, often a wrong price or no price is asked. Non-regular potential buyers, too, may be unsure if they have little experience with buying at an auction or when the auction is an auction of a non-regular entity. As a consequence, potential buyers may refrain from bidding. In general, it may be stated that a slow auction process is characteristic of a bidding auction.
2. In a bidding auction a potential buyer often waits long before bidding so as to prevent the price being pushed up by him.
3. In the double drop auction an interested potential buyer is forced to adopt an active attitude.
4. As a result, the process of the double drop auction can run its course fast. In the above-described specific embodiment, e.g., within 51 hours. This can be a very important factor for many sellers, for instance, if the seller is hard up for money or, for instance, if he wants to sell perishable goods.
5. Furthermore, in the double drop auction there is always a price that can be accepted directly.
6. The seller in the double drop auction is not dependent on particular group actions, on which a seller who makes use of a model such as the Groupon model does depend.
7. In the double drop auction the auctioneer and/or manager of the system takes care of a group of potential buyers by informing them through the so-called Article Alerts. Further, each potential buyer decides whether he wishes to accept an offer and at what price he does so.
8. Also, the seller in the double drop auction, if he so wishes, can fix a minimum asking price.
9. For a potential buyer in the double drop auction there is no uncertainty about the minimum price for which a seller wants to sell the entity.
10. The double drop auction offers people an opportunity to apply themselves, possibly even professionally, to bringing in Mine Money. The auctioneer can create a money-making business model allowing many Mine Money Hunters to make money. Going after Mine Money resembles gambling, but can be done entirely legally. The risk for the Mine Money Hunter may be that when in the second round of the double drop auction no higher price is accepted by any other potential buyer, this Mine Money Hunter may be obliged to buy the entity for the price accepted by him in the first round. Optionally, in that case too, the Mine Money Hunter is entitled to the Mine Money, thus getting some discount on the price accepted by him.
11. As the auction process in the double drop auction can take place automatically for the most part, for instance, with the aid of instruments such as the Article Alert, the Price Alert, the Mine Alert and/or the AutoMine button, the auction process can take place while one or more of the parties, i.e., the seller and the potential buyers, are doing other things.
12. In the double drop auction a seller may even collect a higher price than he has entered as a starting price in the first round.
13. Also, the double drop auction is doubly exciting to boot.

In addition, the double drop auction may be advantageous for an auctioneer and/or manager of an electronic system for drop auction of an entity. Such advantages comprise:
1. There need not be any limitations on the number of sellers and/or entities to be auctioned.
2. The exploitation costs can be relatively very low.
3. A relatively low database capacity is needed, compared with the number of sales.
4. The users of the system, i.e., sellers, buyers and/or potential buyers, including Mine Money Hunters, will typically be very satisfied owing to the fast results to be achieved.
5. Much revenue from commission can be generated, for instance, owing to the potentially large number of auctions to be facilitated.
6. With an electronic system, in addition, advertising revenues can be generated as well.
7. Alternatively or additionally, software written for the double auction system can be licensed to other businesses, these other businesses then paying the auctioneer and/or manager of the system commission on the double drop auctions facilitated by these other businesses.
8. The double drop auction also has a socially responsible side. It allows small producers, e.g., those of coffee, soy, or tea, to reach an international market, bypassing the purchasing cartels.
9. Moreover, the double drop auction is much more flexible than static sales models such as Ebay and Groupon.
10. Also, Mine Money Hunters, certainly when there are many, can stimulate the double drop auctions.

In addition, the invention relates to an electronic system for drop auction of an entity. The electronic system comprises a first interface for allowing a selling party to enter a definition of the entity to be auctioned and a maximum asking price, a processor for determining an asking price which drops stepwise from the maximum asking price to a minimum asking price and for generating a message with information about a current asking price, a second interface for transmitting the message via an information network to potential buyers for electronically offering the entity, and a third interface for allowing a buying party to accept the current asking price, the processor being arranged to determine the asking price on the basis of number, size and/or duration of the steps by which the asking price drops as predetermined by a manager of the system.

Furthermore, the invention relates to a computer program product. A computer program product can include a set of computer executable instructions, stored on a carrier, such as a flash memory, a CD or a DVD. The set of computer executable instructions which enable a programmable computer to carry out the above-described method can also be made available by downloading from an external server, e.g., via the Internet. The method may be carried out wholly or partly in software, implemented on a computer having a single or multiple processor structure. In principle, steps of the method can be carried out on different processors or computers.

The invention will be further elucidated on the basis of an exemplary embodiment which is represented in the accompanying drawings.

In the drawings,

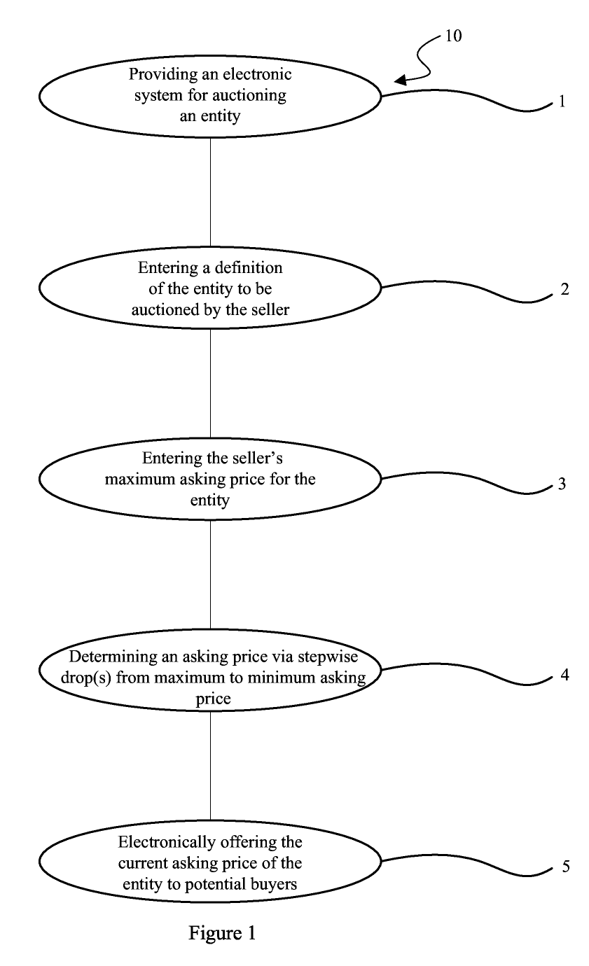

FIG. 1 is a schematic representation of a method for drop auction of an entity; and

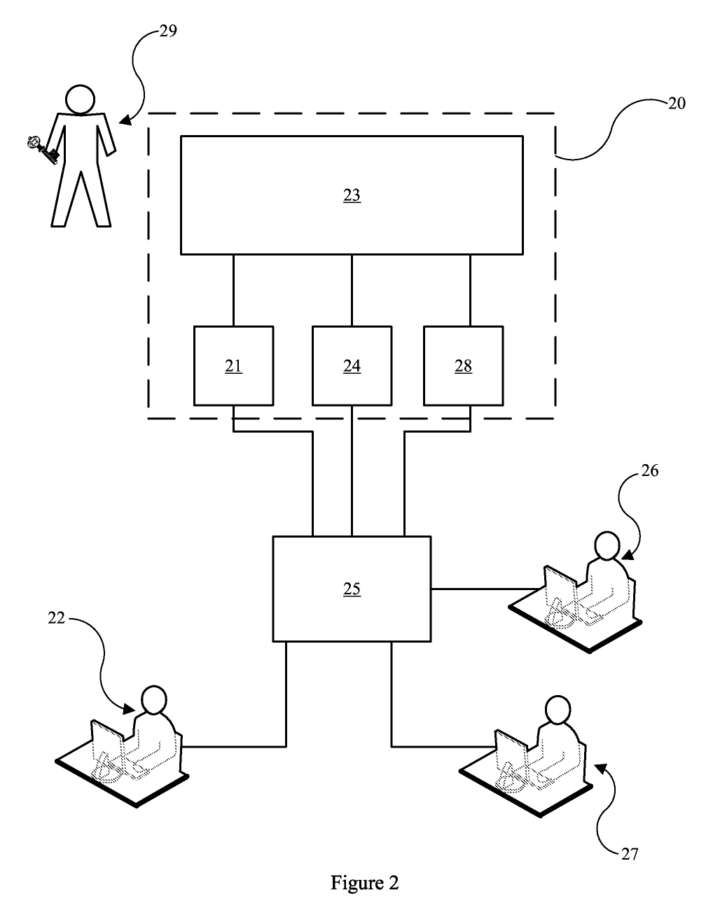

FIG. 2 is a schematic representation of an electronic system for drop auction of an entity.

It is noted that the Figures are only schematic representations of a non-limiting exemplary embodiment of the invention. In the Figures, like or corresponding parts are represented with the same reference numerals.

FIG. 1 shows a schematic representation of a method 10 for drop auction of an entity. The method comprises the steps of:

providing an electronic system for auction of an entity 1;

allowing a selling party to enter a definition of the entity to be auctioned into the electronic system 2;

allowing the selling party to enter a maximum asking price 3;

determining an asking price which drops stepwise from the maximum asking price to a minimum asking price 4, and

electronically offering the entity by informing potential buyers about the current asking price 5,

wherein the number, the size and/or the duration of the steps by which the asking price drops is predetermined by a manager of the electronic system.

It is noted that the steps of the method need not necessarily be carried out in the above-described order. Thus, for instance, the step 3 of having the selling party enter the maximum asking price can be carried out before or simultaneously with the step 2 of having the selling party enter the definition of the entity to be auctioned into the electronic system.

In FIG. 2 a schematic representation is shown of an electronic system 20 for drop auction of an entity. The electronic system 20 comprises a first interface 21 for allowing a selling party 22 to enter a definition of the entity to be auctioned and a maximum asking price, a processor 23 for determining an asking price which drops stepwise from the maximum asking price to a minimum asking price and for generating a message with information about a current asking price, a second interface 24 for transmitting the message via an information network 25 to potential buyers 26, 27 for electronically offering the entity, and a third interface 28 for allowing a buying party 27 to accept the current asking price. The processor 23 is arranged to determine the asking price on the basis of number, size and/or duration of the steps by which the asking price drops as predetermined by a manager 29 of the system 20.

Through the optional functionality of sending messages, as described above, e.g., a Price alert, the manager of the electronic system can gain knowledge about potential buyers and sellers. Buyers and sellers, too, can thus gather market information advantageously. Furthermore, the seller can get a higher price for the entity because the auction cycle is traversed twice. By utilizing the advantages of a drop auction the sale of entities can take place relatively fast, since in this system an interested buyer is given an incentive to respond relatively fast.

The invention is not limited to the exemplary embodiments described here. Many variants are possible.

Such variants will be clear to one skilled in the art and are understood to be within the scope of the invention, as set forth in the following claims.

1. A method for drop auction of an entity, comprising the steps of:
providing an electronic system for auction of an entity;
allowing a selling party to enter a definition of the entity to be auctioned into the electronic system;
allowing the selling party to enter a maximum asking price;
determining an asking price which drops stepwise from the maximum asking price to a minimum asking price, and
electronically offering the entity by informing potential buyers about a current asking price,
wherein the number, the size and/or the duration of the steps by which the asking price drops is predetermined by a manager of the electronic system.

2. The method according to claim 1, wherein the step size is constant.

3. The method according to claim 1, wherein the number of steps is chosen in a range of between about 10 and about 1,000.

4. The method according to claim 1, wherein the duration of the steps is chosen in a range of between about one second and about one day.

5. The method according to claim 1, further comprising allowing the selling party to enter a minimum asking price.

6. The method according to claim 1, wherein the electronic offering of the entity is ended by allowing a buying party to accept the asking price in the electronic system.

7. The method according to claim 1, wherein the electronic offering of the entity is ended upon expiry of a predetermined period in which the entity was being offered at the minimum asking price.

8. The method according to claim 1, wherein a potential buyer receives a message when an entity pre-selected by the potential buyer is being offered.

9. The method according to claim 1, wherein a potential buyer receives a message when the asking price approaches an amount predetermined by the potential buyer.

10. The method according to claim 1, wherein the electronic system automatically receives a message of acceptance from a potential buyer when the asking price reaches an amount prefixed by the potential buyer.

11. The method according to claim 1, wherein the electronic system receives a message from a potential buyer with a bid for the entity fixed by the potential buyer.

12. The method according to claim 1, further comprising the steps of:
carrying out a second auction round, after acceptance of a current asking price by a provisional buyer,
determining a second stepwise dropping asking price,
electronically offering the entity by informing potential buyers about a current second asking price, and
fixing an agreed price for the entity when a definitive buyer accepts a current second asking price, the agreed price consisting of the sum of the first accepted asking price and the second accepted asking price.

13. The method according to claim 12, wherein the provisional buyer is entitled to a percentage of the first accepted asking price.

14. The method according to claim 12, wherein the provisional buyer also becomes definitive buyer when in the second auction round no asking price is accepted.

15. An electronic system for drop auction of an entity, comprising:
a first interface for allowing a selling party to enter a definition of the entity to be auctioned and a maximum asking price;
a processor for determining an asking price which drops stepwise from the maximum asking price to a minimum asking price and for generating a message with information about a current asking price;
a second interface for transmitting the message via an information network to potential buyers for electronically offering the entity, and
a third interface for allowing a buying party to accept the current asking price,
wherein the processor is arranged to determine the asking price on the basis of number, size and/or duration of the steps by which the asking price drops as predetermined by a manager of the system.

16. A computer program product for carrying out an auction of an entity by drop auction, wherein the computer program product comprises a non-transitory computer readable medium having encoded thereon a code which causes a processor to carry out the steps of:
allowing a selling party to enter a definition of the entity to be auctioned into the processor;
allowing the selling party to enter a maximum asking price into the processor;
determining an asking price which drops stepwise from the maximum asking price to a minimum asking price, and
electronically offering the entity by informing potential buyers about the current asking price,
wherein the number, the size and/or the duration of the steps by which the asking price drops is predetermined by a manager of the electronic system.
